(19) United States
(12) Patent Application Publication
(10) Pub. No.: US 2020/0154490 A1
(43) Pub. Date: May 14, 2020

(54) METHOD AND APPARATUS FOR ESTABLISHING USER EQUIPMENT COOPERATION GROUP

(71) Applicant: HUAWEI TECHNOLOGIES CO., LTD., Shenzhen (CN)

(72) Inventors: Zhengzheng XIANG, Shanghai (CN); Jiyong PANG, Shanghai (CN); Hongjia SU, Shanghai (CN)

(21) Appl. No.: 16/738,762

(22) Filed: Jan. 9, 2020

Related U.S. Application Data
(63) Continuation of application No. PCT/CN2018/090704, filed on Jun. 11, 2018.

(30) Foreign Application Priority Data
Jul. 26, 2017 (CN) 201710620174.1

(51) Int. Cl. H04W 74/08; H04L 5/00; H04W 74/00; H04W 76/27; H04W 72/12; H04L 1/00; H04W 76/14

(52) U.S. Cl. CPC H04W 74/0833; H04L 5/0048; H04W 74/006; H04L 5/0053; H04L 2027/0095; H04W 72/121; H04L 1/0026; H04W 76/14; H04W 76/27

(57) ABSTRACT

A method and an apparatus for establishing a user equipment cooperation group are provided. The method includes: receiving, by a neighboring user equipment (NUE), a first message sent by a target user equipment (TUE), where the first message include s a first preamble sequence and a data part of the TUE, and the first preamble sequence is used for random access between the TUE and the NUE; determining, by the NUE, the TUE based on the data part of the TUE; sending, by the NUE, a second message to a base station, where the second message includes a second preamble sequence and the data part of the NUE, and the second preamble sequence is used for random access between the NUE and the base station; and receiving, by the NUE, a third message sent by the base station, where the third message includes a user equipment cooperation group identifier

### CROSS-REFERENCE TO RELATED APPLICATIONS

This application is a continuation of International Application No. PCT/CN2018/090704, filed on Jun. 11, 2018, which claims priority to Chinese Patent Application No. 201710620174.1, filed on Jul. 26, 2017, the disclosures of which are herein incorporated by reference in their entireties.

### TECHNICAL FIELD

This application relates to the field of wireless communications technologies, and in particular, to a method and an apparatus for establishing a user equipment cooperation group.

### BACKGROUND

With the rapid development of wireless communications technologies, supported services also develop from initial voice and short message services to currently supported wireless high-speed data communication. A quantity of wireless connections in the world is in a sustained and high-speed increase. Various new wireless service types such as internet of things, virtual reality (VR), and the like are emerging in a great quantity. Therefore, it requires a higher demand on the 5-generation (5G) mobile communications technology system. User cooperation is one of features mainly supported by the 5G system, and can significantly improve a capacity of the system and a coverage of a network. A load of an evolved NodeB (eNB) end can also be reduced. In this case, a premise of the user cooperation is to establish a user equipment cooperation group.

In the prior art, the user equipment cooperation group is established in a contention-based four-step random access manner. Specifically, as shown in FIG. 1, the eNB first notifies, by using radio resource control (RRC) layer signaling, target user equipment (TUE) about an index that is of a preamble sequence and that is used for device to device (D2D) random access. The TUE then sends, based on an indication of the eNB, a corresponding preamble sequence that is used for the D2D random access to neighboring user equipment (NUE). After receiving the D2D random access preamble sequence sent by the TUE, and if the NUE is willing to participate in the user cooperation, the NUE sends an ordinary random access preamble sequence to the eNB through a physical random access channel (PRACH). Then after receiving the ordinary random access preamble sequence sent by the NUE, the eNB sends a random access response (RAR) to the NUE, and after receiving the RAR sent by the eNB, the NUE further sends to the eNB a cell radio network temporary identifier (C-RNTI) of the NUE and a sequence index of the received D2D random access preamble sequence sent by the TUE. Finally, the eNB decides, based on received information sent by the NUE, whether the NUE becomes a cooperating user equipment (CUE) of the TUE. If the NUE becomes the CUE of the TUE, the eNB use the NUE and the TUE to form a user equipment cooperation group, and a D2D RAR is sent to the TUE and a plurality of NUEs that become the CUE of the TUE, where the D2D RAR includes a group identifier allocated by the eNB for the user equipment cooperation group and includes other related information. The user equipment cooperation group is established in the foregoing manner, which causes a relatively long delay of a group establishing process and relatively low efficiency of the group establishing process.

To sum up, how to reduce the delay of the group establishing process and improve the efficiency of the group establishing process is a current problem that needs to be resolved.

### SUMMARY

This application provides a method and an apparatus for establishing a user equipment cooperation group, thereby reducing a delay of a group establishing process and improving efficiency of the group establishing process.

According to a first aspect, a method for establishing a user equipment cooperation group is provided in this application, including: receiving, by neighboring user equipment (NUE), a first message sent by target user equipment (TUE), where the first message includes a first preamble sequence and a data part of the TUE, and the first preamble sequence is used for random access between the TUE and the NUE; sending, by the NUE, a second message to a base station, where the second message includes a second preamble sequence and a data part of the NUE, and the second preamble sequence is used for random access between the NUE and the base station; and receiving, by the NUE, a third message sent by the base station, where the third message includes a user equipment cooperation group identifier.

By using the foregoing method, based on the received first message sent by the TUE, if the NUE is willing to participate in user equipment cooperation of the TUE, the NUE sends the second message to the base station. After receiving the second message, the base station determines a user equipment cooperation group to which the NUE belongs, and sends the user equipment cooperation group identifier to the NUE. After receiving the user equipment cooperation group identifier, the NUE determines the user equipment cooperation group to which the NUE belongs. The user equipment cooperation group is established in the foregoing manner, which reduces a delay of a group establishing process, and improves efficiency of the group establishing process.

In one embodiment, the data part of the TUE includes identification information of the TUE and/or user equipment cooperation request information of the TUE.

By using the method, the NUE determines, based on the received identification information of the TUE and/or user equipment cooperation request information of the TUE, a TUE that needs to perform the user equipment cooperation.

In one embodiment, the data part of the TUE further includes type indication information, used to indicate a type of the first message.

By using the method, the NUE determines, based on the type of the first message, that the first message is a message that is between devices and that is sent by the TUE.

In one embodiment, the data part of the NUE includes at least one of identification information of the NUE, identification information of the TUE, an index of the first preamble sequence, or a channel quality indicator of the TUE.

In one embodiment, the data part of the NUE further includes type indication information, used to indicate a type of the second message.

By using the method, the base station determines, based on the type of the second message, that the second message is a message between a device and the base station.

According to a second aspect, a method for establishing a user equipment cooperation group is provided in this application, including: receiving, by target user equipment (TUE), radio resource control (RRC) signaling sent by a base station; determining, by the TUE based on the RRC signaling, a device to device (D2D) physical random access channel (PRACH) resource that is configured by the base station for the TUE; sending, by the target user equipment, a first message to neighboring user equipment (NUE) through the PRACH resource, where the first message includes a first preamble sequence and a data part of the TUE, and the first preamble sequence is used for random access between the TUE and the NUE; and receiving, by the TUE, a fourth message sent by the base station, where the fourth message includes a user equipment cooperation group identifier.

In one embodiment, the data part of the TUE includes identification information of the TUE and/or user equipment cooperation request information of the TUE.

In one embodiment, the data part of the TUE further includes type indication information, used to indicate a type of the first message.

In one embodiment, the fourth message further includes a random access response (RAR) and contention resolution information.

In one embodiment, the fourth message further includes identification information of the NUE that becomes cooperating user equipment (CUE) of the TUE.

By using the method, the TUE determines, based on the received identification information of the NUE of the cooperating user equipment (CUE) of the TUE, a NUE that becomes the CUE of the TUE.

According to a third aspect, a method for delivering control information is provided in this application, including: sending, by abase station, radio resource control (RRC) signaling to target user equipment (TUE), where the RRC signaling is used to indicate a device to device (D2D) physical random access channel (PRACH) resource that is configured by the base station for the TUE; receiving, by the base station, a second message sent by neighboring user equipment (NUE) of the TUE, where the second message includes a second preamble sequence and a data part of the NUE, and the second preamble sequence is used for random access between the NUE and the base station; determining, by the base station based on the second message, a user equipment cooperation group, and allocating a user equipment cooperation group identifier; and sending, by the base station, a third message to the NUE and a fourth message to the TUE, where both the third message and the fourth message include the user equipment cooperation group identifier.

In one embodiment, the third message further includes identification information of the TUE.

In one embodiment, the fourth message further includes identification information of the NUE that becomes cooperating user equipment (CUE) of the TUE.

In one embodiment, the fourth message further includes a random access response (RAR) and contention resolution information.

In one embodiment, the data part of the NUE includes at least one of identification information of the NUE, identification information of the TUE, an index of a first preamble sequence, or a channel quality indicator of the TUE.

In one embodiment, the data part of the NUE further includes type indication information, used to indicate a type of the second message.

In one embodiment, the identification information of the TUE is carried in a data part of the TUE in a first message sent by the TUE to the NUE through the PRACH resource.

In one embodiment, the first message includes a first preamble sequence and the data part of the TUE, and the first preamble sequence is used for random access between the TUE and the NUE.

In one embodiment, the data part of the TUE includes the identification information of the TUE and/or user equipment cooperation request information of the TUE.

In one embodiment, the data part of the TUE further includes type indication information, used to indicate a type of the first message.

In one embodiment, the base station may distinguish the first message from the second message through a position of the physical random access channel (PRACH) resource.

According to a fourth aspect, a neighboring user equipment (NUE) is provided in this application, including: a receiving unit, configured to receive a first message sent by target user equipment (TUE), where the first message includes a first preamble sequence and a data part of the TUE, and the first preamble sequence is used for random access between the TUE and the NUE; a sending unit, configured to send a second message to abase station, where the second message includes a second preamble sequence and a data part of the NUE, and the second preamble sequence is used for random access between the NUE and the base station; where the receiving unit is further configured to receive a third message sent by the base station, and the third message includes a user equipment cooperation group identifier.

By using the foregoing method, based on the received first message sent by the TUE, if the NUE is willing to participate in user equipment cooperation of the TUE, the NUE sends the second message to the base station. After receiving the second message, the base station determines a user equipment cooperation group to which the NUE belongs, and sends the user equipment cooperation group identifier to the NUE. After receiving the user equipment cooperation group identifier, the NUE determines the user equipment cooperation group to which the NUE belongs. The user equipment cooperation group is established in the foregoing manner, which reduces a delay of a group establishing process, and improves efficiency of the group establishing process.

In one embodiment, the data part of the TUE includes identification information of the TUE and/or user equipment cooperation request information of the TUE.

In one embodiment, the data part of the TUE further includes type indication information, used to indicate a type of the first message.

In one embodiment, the data part of the NUE includes at least one of identification information of the NUE, identification information of the TUE, an index of the first preamble sequence, or a channel quality indicator of the TUE.

In one embodiment, the data part of the NUE further includes type indication information, used to indicate a type of the second message.

According to a fifth aspect, a target user equipment (TUE) is provided in this application, including: a receiving unit, configured to receive radio resource control (RRC) signaling sent by a base station; a processing unit, configured to determine, based on the RRC signaling, a device to device (D2D) physical random access channel (PRACH) resource that is configured by the base station for the TUE; a sending unit, configured to send a first message to neighboring user equipment (NUE) through the PRACH resource, where the first message includes a first preamble sequence and a data part of the TUE, and the first preamble sequence is used for random access between the TUE and the NUE; where the receiving unit is further configured to receive a fourth message sent by the base station, and the fourth message includes a user equipment cooperation group identifier.

In one embodiment, the data part of the TUE includes identification information of the TUE and/or user equipment cooperation request information of the TUE.

In one embodiment, the data part of the TUE further includes type indication information, used to indicate a type of the first message.

In one embodiment, the fourth message further includes a random access response (RAR) and contention resolution information.

In one embodiment, the fourth message further includes identification information of the NUE that becomes cooperating user equipment (CUE) of the TUE.

According to a sixth aspect, a base station is provided in this application, including: a sending unit, configured to send radio resource control (RRC) signaling to target user equipment (TUE), where the RRC signaling is used to indicate a device to device (D2D) physical random access channel (PRACH) resource that is configured by the base station for the TUE; a receiving unit, configured to receive a second message sent by neighboring user equipment (NUE) of the TUE, where the second message includes a second preamble sequence and a data part of the NUE, and the second preamble sequence is used for random access between the NUE and the base station; a processing unit, configured to: determine, based on the second message, a user equipment cooperation group, and allocate a user equipment cooperation group identifier, where the sending unit is further configured to send a third message to the NUE and a fourth message to the TUE, and both the third message and the fourth message include the user equipment cooperation group identifier.

In one embodiment, the third message further includes identification information of the TUE.

In one embodiment, the fourth message further includes identification information of the NUE that becomes cooperating user equipment (CUE) of the TUE.

In one embodiment, the fourth message further includes a random access response (RAR) and contention resolution information.

In one embodiment, the data part of the NUE includes at least one of identification information of the NUE, identification information of the TUE, an index of a first preamble sequence, or a channel quality indicator of the TUE.

In one embodiment, the data part of the NUE further includes type indication information, used to indicate a type of the second message.

In one embodiment, the identification information of the TUE is carried in a data part of the TUE in a first message sent by the TUE to the NUE through the PRACH resource.

In one embodiment, the first message includes a first preamble sequence and the data part of the TUE, and the first preamble sequence is used for random access between the TUE and the NUE.

In one embodiment, the data part of the TUE includes the identification information of the TUE and/or user equipment cooperation request information of the TUE.

In one embodiment, the data part of the TUE further includes type indication information, used to indicate a type of the first message.

In one embodiment, the base station may distinguish the first message from the second message through a position of the physical random access channel (PRACH) resource.

According to a seventh aspect, user equipment is provided in this application, including a communications interface, a processor, and a memory, where the memory is configured to store a software program; and the processor is configured to: invoke and execute the software program stored in the memory, to implement the method according to the first aspect and any design of the first aspect, or the second aspect and any design of the second aspect by receiving and sending data through the communications interface.

According to an eighth aspect, a base station is provided in this application, including a communications interface, a processor, and a memory, where the memory is configured to store a software program; and the processor is configured to: invoke and execute the software program stored in the memory, to implement the method according to the third aspect and any design of the third aspect by receiving and sending data through the communications interface.

According to a ninth aspect, a computer-readable storage medium is provided in this application, where the computer-readable storage medium stores a computer instruction, and when the instruction is run on a computer, the computer is enabled to perform the method according to the first aspect and any design of the first aspect, or the second aspect and any design of the second aspect, or the third aspect and any design of the third aspect.

### BRIEF DESCRIPTION OF DRAWINGS

FIG. 1 is a flowchart of a method for establishing a user equipment cooperation group in the prior art;

FIG. 2 is a diagram of an application scenario according to an embodiment this application;

FIG. 3 is a flowchart of a contention-based four-step random access method in the prior art;

FIG. 4 is a flowchart of a contention-based two-step random access method according to an embodiment of this application;

FIG. 5 is a flowchart of a method for establishing a user equipment cooperation group according to an embodiment of this application;

FIG. 6 is a structural diagram of a first message according to one embodiment of this application;

FIG. 7 is a structural diagram of a second message according to one embodiment of this application;

FIG. 8 is a flowchart of another method for establishing a user equipment cooperation group according to one embodiment of this application;

FIG. 9 is a schematic diagram of user equipment according to one embodiment of this application;

FIG. 10 is a schematic diagram of another user equipment according to one embodiment of this application;

FIG. 11 is a schematic diagram of a base station according to one embodiment of this application; and

FIG. 12 is a schematic structural diagram of hardware of an apparatus according to one embodiment of this application.

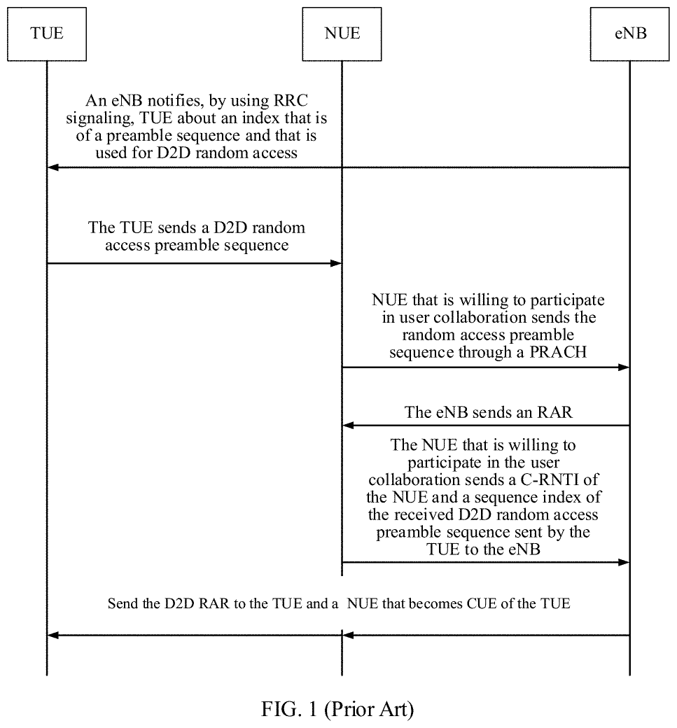

### DESCRIPTION OF EMBODIMENTS

To make the objectives, technical solutions, and advantages of this application clearer, the following further describes this application in detail with reference to the accompanying drawings.

A method and an apparatus for establishing a user equipment cooperation group according to this application can resolve problems of a relatively long delay of a group establishing process and relatively low efficiency of the group establishing process that exist in the prior art. The methods and the apparatus are based on a same inventive concept. Because the methods and the apparatus have a similar principle to resolve a problem, for implementations of the methods and the apparatus, refer to each other, and repeated content is not described again.

In embodiments of this application, in some cases, user equipment (UE) may refer to a terminal or a mobile device, for example, a mobile phone, a personal digital assistant (PDA), a handheld or laptop computer, and a similar device with a telecommunication capability. In other cases, the user equipment may refer to a device with the similar capability but itself cannot be carried, for example, a desktop computer, a set top box, or a network device. The user equipment may further refer to any hardware or software component of a communications session that can terminate a user. In addition, user equipment described in the embodiments of this application may be referred to as a subscriber unit, a subscriber station, a mobile station, a remote station, a remote terminal, a user terminal, a wireless communications device, a user agent, or a user apparatus.

In the embodiments of this application, a base station may include a base station in a conventional wireless communications system such as 2G/3G, or may include a system and a device that are used to improve a peer device in the conventional wireless communications system. Such an advanced or next generation device may be included in an evolved wireless communications standard (for example, long term evolution (LTE)). For example, the LTE system may include an evolved universal terrestrial radio access network (E-UTRAN) node B (NB) or eNB, a wireless access point, or a similar component. Any such component is referred to as eNB in this specification. However, it should be understood that such component may not be eNB. For example, in a next generation communications system or a 5G communications system, the eNB of the LTE system may be replaced by “gNB”.

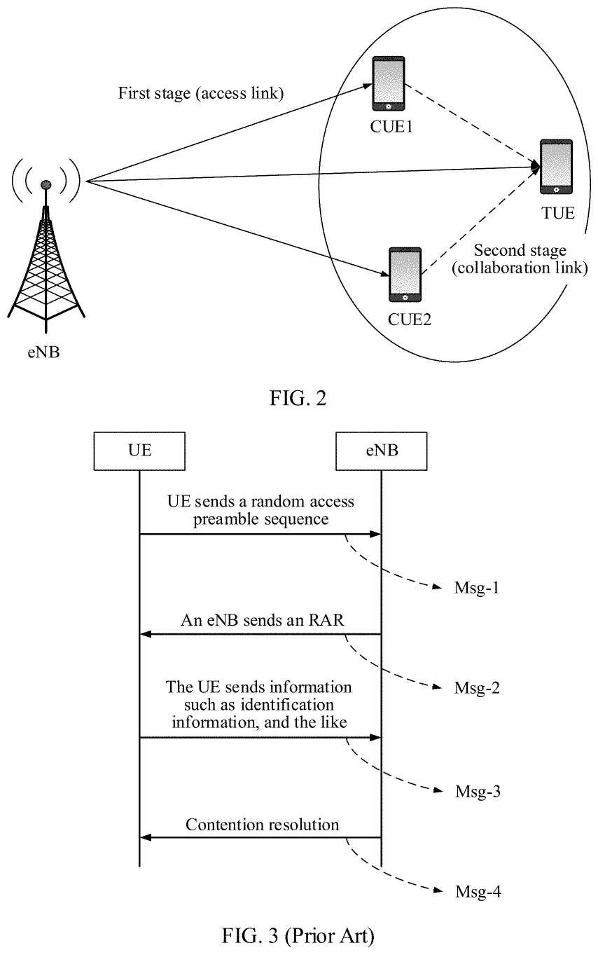

In the embodiments of this application, user equipment cooperation is one of features mainly supported by a 5G mobile communications technology system, and can significantly improve a capacity of the system and a coverage of a network. A load of an evolved NodeB end can also be reduced. A typical user equipment cooperation scenario is shown in FIG. 2. Transmission based on the user equipment cooperation mainly has the following two stages. The first stage is that the eNB sends data to TUE and related CUE for example, CUE 1 and CUE 2 in FIG. 2, in a multi-cast manner. The second stage is that the CUE 1 and the CUE 2 forward a correctly received signal to the TUE, where the forwarding manner may be amplify-and-forward, decode-and-forward, compress-and-forward, or the like. The TUE may decode a combination of a received transmission signal of the eNB in the first stage and a received forwarding signal of the CUE 1 and CUE 2 in the second stage, thereby improving a receiving performance. To sum up, in user equipment cooperation communication, the TUE and several CUEs serving for the TUE may form a user equipment cooperation group. For example, the TUE, the CUE 1, and the CUE 2 in FIG. 2 form a user equipment cooperation group. For any UE, the UE may be either TUE of a self-centered user equipment cooperation group, or CUE or CUEs of one or more other user equipment cooperation groups. NUE that is in the same user equipment cooperation group as the TUE is the CUE of the TUE. There may be a plurality of different user equipment cooperation groups in a same cell.

A possible manner in which the user equipment cooperation group is established is to establish the user equipment cooperation group by using contention-based four-step random access. The random access is a basic process in the wireless communications network, to enable the UE to obtain uplink synchronization and further perform uplink transmission. In the LTE network, there are two situations in contention-based random access. Situation 1 is the contention-based four-step random access, including the following 4 main steps. The first step is that the UE sends a random access preamble sequence to the eNB through a physical random access channel (PRACH). The second step is that after receiving the preamble sequence sent by the UE, the eNB sends a random access response (RAR) to the UE through a physical downlink shared channel (PDSCH). In the random access response (RAR), the eNB allocates a temporary C-RNTI to the UE, and allocates an uplink resource to data that is to be sent by the UE in the third step. The third step is that after receiving the RAR sent by the eNB, the UE may send, in a physical uplink shared channel (PUSCH) based on indication information of the RAR, an identification of the UE such as the C-RNTI and other related information to the eNB. And the fourth step is a contention resolution, that is, the eNB sends a message to UE that successfully performs the random access, while other UEs that fail to perform the random access need to re-perform the random access process.

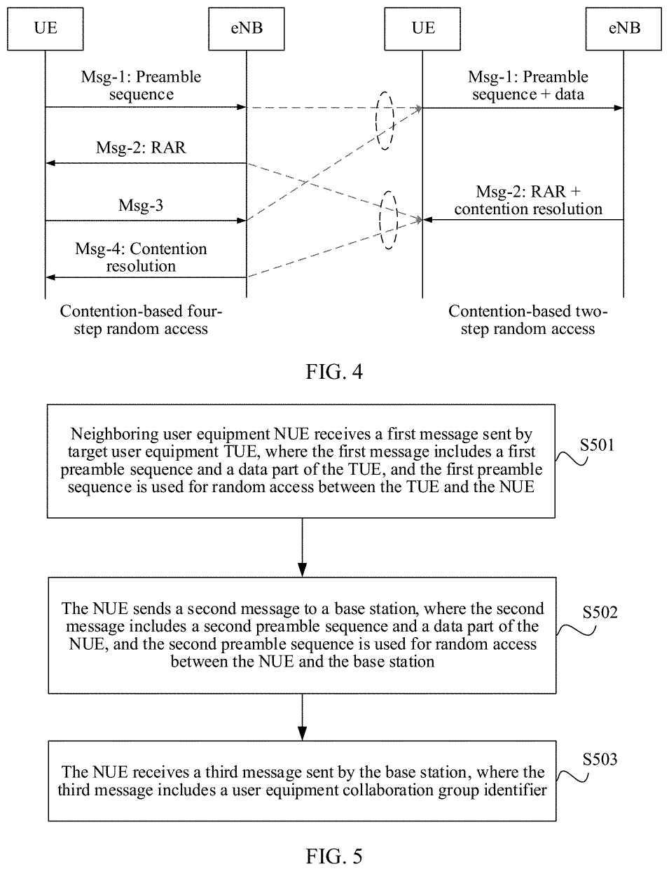

FIG. 3 schematically shows a process of the contention-based four-step random access in the prior art, and messages sent by the UE and the eNB are sequentially referred to as a Msg-1, a Msg-2, a Msg-3 and a Msg-4. Because a delay of the contention-based four-step random access process in situation 1 is relatively long, situation 2 of contention-based two-step random access is also provided including the following two steps. The first step is that the UE sends a new Msg-1 to the eNB, where the new Msg-1 includes information about a random access preamble sequence, a UE identification, and the like. The second step is that the eNB sends a new Msg-2 to the UE, where the new Msg-2 includes an RAR and contention resolution information. FIG. 4 shows the contention-based two-step random access and a relationship between the contention-based two-step random access and contention-based four-step random access. That is, the Msg-1 and the Msg-3 that are in the existing contention-based four-step random access solution are combined into a new Msg-1, and the Msg-2 and the Msg-4 are combined into a new Msg-2.

In user equipment cooperation group communication, a user equipment cooperation group generally needs to be established, and user equipment in the user equipment cooperation group includes TUE and CUE. However, before the user equipment cooperation group is established, user equipment that may provide cooperation is usually user equipment near the TUE. The user equipment may be referred to as neighboring user equipment (NUE). To establish the user equipment cooperation group, a group identifier of the user equipment cooperation group needs to be sent to the user equipment in the user equipment cooperation group.

FIG. 5 is a flowchart of a method for establishing a user equipment cooperation group according to this application. As shown in FIG. 5, the method shows a process for one TUE and one NUE to establish the user equipment cooperation group. Furthermore, a process for one TUE and a plurality of NUEs to establish a group may be obtained in a similar manner, and the method includes the following operations.

Operation S501: The neighboring user equipment (NUE) receives a first message sent by the target user equipment (TUE), where the first message includes a first preamble sequence and a data part of the TUE, and the first preamble sequence is used for random access between the TUE and the NUE.

Specifically, the first message may be a D2D-Msg-1. The D2D-Msg-1 is a message for random access between user equipment and includes a D2D random access preamble sequence. The D2D-Msg-1 may be delivered through a D2D PRACH resource that is configured by a base station for the TUE, and the first preamble sequence may be the D2D random access preamble sequence. The data part of the TUE includes identification information of the TUE and/or user equipment cooperation request information of the TUE, or may further include type indication information, used to indicate a type of the first message, where the type of the first message is a message between devices.

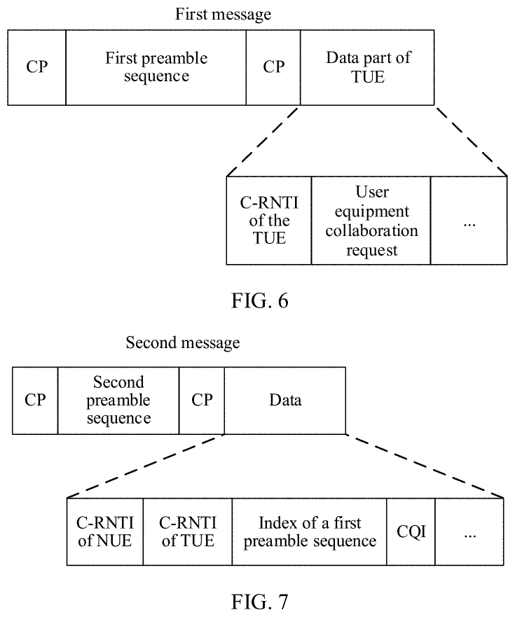

FIG. 6 is a specific structural diagram of the first message. As shown in FIG. 6, the first message includes a D2D random access preamble sequence of the TUE and the data part of the TUE. There is a cyclic prefix (CP) in front of both the D2D random access preamble sequence and the data part of the TUE. The data part of the TUE may include identification information and a user equipment cooperation request, where the identification information may be a cell radio network temporary identifier (C-RNTI). A structure of the first message may alternatively not include the CP.

Operation S502: The NUE sends a second message to the base station, where the second message includes a second preamble sequence and a data part of the NUE, and the second preamble sequence is used for random access between the NUE and the base station.

Specifically, the second message may be a new Msg-1 in contention-based two-step random access. The NUE sends the Msg-1 to the base station through a PRACH resource. The data part of the NUE may include at least one of identification information of the NUE, identification information of the TUE, an index of a first preamble sequence, or a channel quality indicator (CQI) of the TUE, and the data part of the NUE may further include type indication information, used to indicate a type of the second message.

FIG. 7 is a specific structural diagram of the second message. As shown in FIG. 7, the second message includes the second preamble sequence and the data part of the NUE. In front of the second preamble sequence and the data part of the NUE, there may be a CP, or may be no CP, which is not limited in this application. The foregoing data part of the NUE may include a C-RNTI of the NUE, a C-RNTI of the TUE, the index of the first preamble sequence, and the foregoing channel quality indicator (CQI) of the TUE.

Operation S503: The NUE receives a third message sent by the base station, where the third message includes a user equipment cooperation group identifier.

Specifically, the third message may be a new Msg-2 in the contention-based two-step random access.

In one embodiment, after operation S501, the method further includes: determining, by the NUE, the TUE based on the data part of the TUE. Specifically, the NUE determines the TUE based on the identification information of the TUE included in the data part of the TUE.

In this embodiment of this application, NUE sends, based on the received first message sent by the TUE, a second message to the base station. After receiving the second message, the base station determines a user equipment cooperation group to which the NUE belongs, and sends the user equipment cooperation group identifier to the NUE. After receiving the user equipment cooperation group identifier, the NUE determines the user equipment cooperation group to which the NUE belongs. The user equipment cooperation group is established in the foregoing manner, which reduces a delay of a group establishing process, and improves efficiency of the group establishing process.

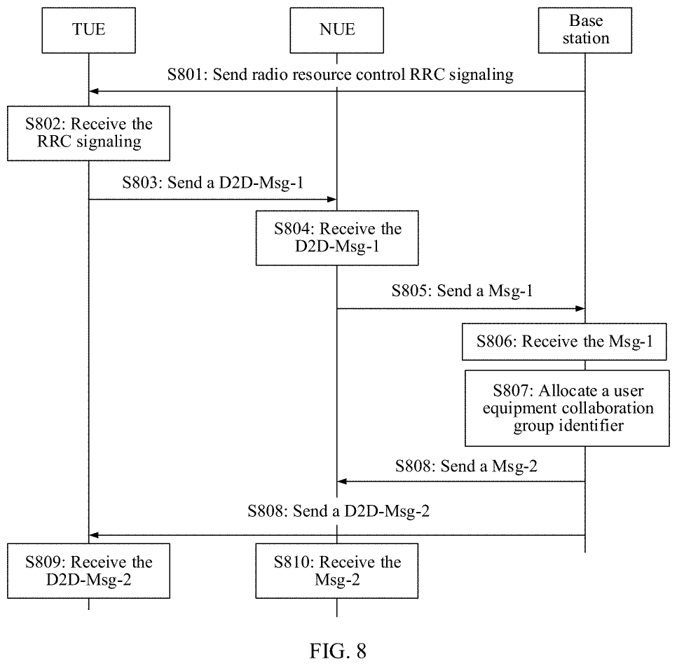

FIG. 8 is a flowchart of another method for establishing a user equipment cooperation group according to an embodiment of this application. As shown in FIG. 8, a first message may be a D2D-Msg-1, a second message may be a new Msg-1, a third message may be a new Msg-2, and a fourth message sent by a base station to the TUE may be a D2D-Msg-2. The method specifically includes the following operations.

Operation S801: The base station sends radio resource control (RRC) signaling to target user equipment (TUE).

Operation S802: The TUE receives the RRC signaling, and determines a D2D PRACH resource that is configured by the base station for the TUE.

Operation S803: The TUE sends the D2D-Msg-1 to NUE through the PRACH resource.

Operation S804: The NUE receives the D2D-Msg-1 sent by the TUE.

Operation S805: The NUE determines, based on a data part of the TUE, whether to participate in user equipment cooperation of the TUE, and if the NUE determines to participate in the user equipment cooperation initiated by the TUE, the NUE sends the new Msg-1 to the base station.

Operation S806: The base station receives the new Msg-1 sent by the neighboring user equipment NUE of the TUE.

Operation S807: The base station determines, based on the foregoing new Msg-1, a user equipment cooperation group, and allocates a user equipment cooperation group identifier.

Operation S808: The base station sends the D2D-Msg-2 to the TUE, and sends the new Msg-2 to the NUE.

Operation S809: The TUE receives the D2D-Msg-2 sent by the base station.

Operation S810: The NUE receives the new Msg-2 sent by the base station.

In this embodiment of this application, the foregoing S809 and S810 are not sorted in a sequential order.

In this embodiment of this application, by using an interaction among the base station, the NUE, and the TUE, the base station determines a user equipment cooperation group of the TUE, and notifies the TUE and NUE that becomes CUE of the TUE. The user equipment cooperation group is established in the foregoing manner, which reduces a delay of a group establishing process, and improves efficiency of the group establishing process.

In one embodiment, the base station can distinguish the D2D-Msg-1 from the new Msg-1 through a position of the physical random access channel PRACH resource.

By using the foregoing manner, the base station may quickly determine a type of the received first message or a type of the received second message.

In a possible implementation, the base station sends, through a PDSCH, the D2D-Msg-2 to the TUE and the new Msg-2 to the NUE that becomes the CUE of the TUE, and scrambles a PDCCH corresponding to the foregoing PDSCH. Specifically, in an LTE, the base station may generate, based on time-frequency resource information of a random access preamble sequence sent by UE before, a random access radio network temporary identifier (RA-RNTI), and scrambles the PDCCH by using the RA-RNTI. In this embodiment of this application, because before sending the D2D-Msg-2 and the new Msg-2, the base station has determined the TUE and a C-RNTI of the CUE corresponding to the TUE, the base station may scramble the PDCCH by using the C-RNTI. Alternatively, the base station may add corresponding signaling in downlink control information (DCI) to indicate whether a current PDSCH carries the D2D-Msg-2, the new Msg-2, or other downlink data.

By using the foregoing manner, the base station may quickly determine a type of the received third message or a type of the received fourth message.

Based on the same inventive concept as the method embodiments, this application further provides user equipment shown in FIG. 9, including:
a receiving unit 901, configured to receive a first message sent by target user equipment TUE, where the first message includes a first preamble sequence and a data part of the TUE, and the first preamble sequence is used for random access between the TUE and the NUE;
a sending unit 902, configured to send a second message to a base station, where the second message includes a second preamble sequence and a data part of the NUE, and the second preamble sequence is used for random access between the NUE and the base station; where
the receiving unit 901 is further configured to receive a third message sent by the base station, and the third message includes a user equipment cooperation group identifier.

In this embodiment of this application, a neighboring user equipment (NUE) is provided. Based on the received first message sent by the TUE, if the NUE is willing to participate in user equipment cooperation of the TUE, the NUE sends the second message to the base station. After receiving the second message, the base station determines a user equipment cooperation group to which the NUE belongs, and sends the user equipment cooperation group identifier to the NUE. After receiving the user equipment cooperation group identifier, the NUE determines the user equipment cooperation group to which the NUE belongs. The user equipment cooperation group is established in the foregoing manner, which reduces a delay of a group establishing process, and improves efficiency of the group establishing process.

In one embodiment, the data part of the TUE includes identification information of the TUE and/or user equipment cooperation request information of the TUE; and the data part of the TUE further includes type indication information, used to indicate a type of the first message.

In one embodiment, the data part of the NUE may include at least one of identification information of the NUE, identification information of the TUE, an index of the first preamble sequence, or a channel quality indicator of the TUE; and the data part of the NUE may further include type indication information, used to indicate a type of the second message.

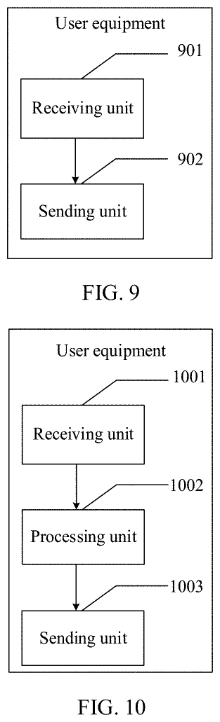

Based on the same inventive concept as the method embodiments, this application further provides user equipment shown in FIG. 10, including:
a receiving unit 1001, configured to receive radio resource control (RRC) signaling sent by a base station;
a processing unit 1002, configured to determine, based on the RRC signaling, a device to device (D2D) physical random access channel (PRACH) resource that is configured by the base station for the TUE;
a sending unit 1003, configured to send a first message to neighboring user equipment (NUE) through the PRACH resource, where the first message includes a first preamble sequence and a data part of the TUE, and the first preamble sequence is used for random access between the TUE and the NUE; where
the receiving unit 1001 is further configured to receive a fourth message sent by the base station, and the fourth message includes a user equipment cooperation group identifier.

In one embodiment, the data part of the TUE may include identification information of the TUE and/or user equipment cooperation request information of the TUE; and the data part of the TUE may further include type indication information, used to indicate a type of the first message.

In one embodiment, the fourth message may further include a random access response (RAR) and contention resolution information; and the fourth message may further include identification information of the NUE that becomes cooperating user equipment (CUE) of the TUE.

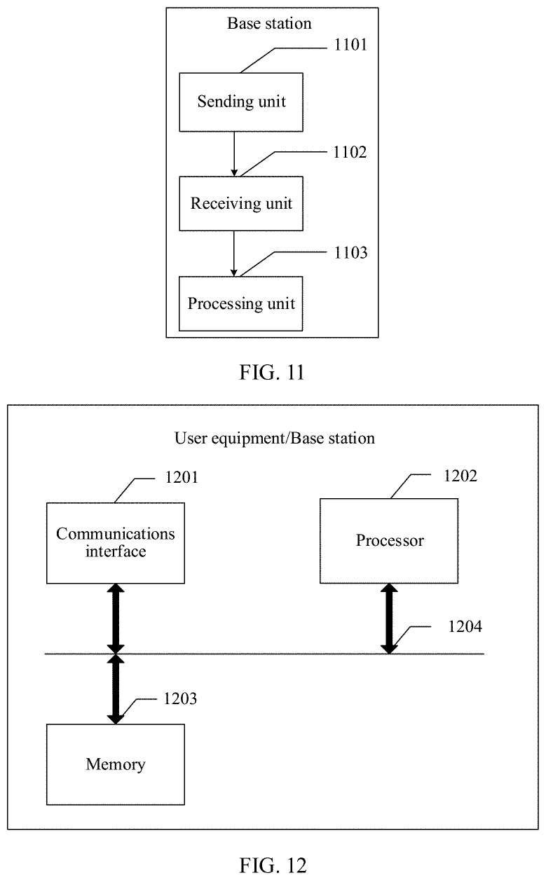

Based on the same inventive concept as the method embodiments, this application further provides a base station shown in FIG. 11, including:
a sending unit 1101, configured to send radio resource control (RRC) signaling to target user equipment (TUE), where the RRC signaling is used to indicate a device to device (D2D) physical random access channel (PRACH) resource that is configured by the base station for the TUE;
a receiving unit 1102, configured to receive a second message sent by neighboring user equipment (NUE) of the TUE, where the second message includes a second preamble sequence and a data part of the NUE, and the second preamble sequence is used for random access between the NUE and the base station;
a processing unit 1103, configured to: determine, based on the second message, a user equipment cooperation group, and allocate a user equipment cooperation group identifier; where
the sending unit 1101 is further configured to send a third message to the NUE and a fourth message to the TUE, and both the third message and the fourth message include the user equipment cooperation group identifier.

In one embodiment, the third message further includes identification information of the TUE.

In one embodiment, the fourth message further includes identification information of the NUE that becomes cooperating user equipment (CUE) of the TUE; and the fourth message further includes a random access response (RAR) and contention resolution information.

In one embodiment, the data part of the NUE may include at least one of identification information of the NUE, identification information of the TUE, an index of a first preamble sequence, or a channel quality indicator of the TUE; and the data part of the NUE may further include type indication information, used to indicate a type of the second message.

In one embodiment, the identification information of the TUE is carried in a data part of the TUE in a first message sent by the TUE to the NUE through the PRACH resource.

In one embodiment, the first message includes a first preamble sequence and the data part of the TUE, and the first preamble sequence is used for random access between the TUE and the NUE.

In one embodiment, the data part of the TUE includes the identification information of the TUE and/or user equipment cooperation request information of the TUE; and the data part of the TUE further includes type indication information, used to indicate a type of the first message.

In one embodiment, the base station may distinguish the first message from the second message through a position of the physical random access channel (PRACH) resource.

Division of the modules in the embodiments of this application is only an example, and is merely logical function division. There may be other division manners during actual implementation. In addition, the functional modules in the embodiments of this application may be integrated into one processor, or each of the modules may exist alone physically, or two or more modules may be integrated into one module. The foregoing integrated module may be implemented in a hardware form or a software function module form.

When the integrated module may be implemented in the hardware form, as shown in FIG. 12, an apparatus in FIG. 12 may be configured to represent user equipment, or may be configured to represent a base station. Hardware of an entity corresponding to the foregoing processing unit may be a processor 1202. The processor 1202 may be a central processing unit (CPU), a digital processing module, or the like. The apparatus may further include a communications interface 1201, the processor 1202 receives a message through the communications interface 1201, and the communications interface 1201 includes the foregoing receiving unit and sending unit. The apparatus further includes a memory 1203, configured to store a program executed by the processor 1202. The memory 1203 may be a nonvolatile memory such as a hard disk drive (HDD) or a solid-state drive (SSD), or may be a volatile memory, for example, a random-access memory (RAM). The memory 1203 is any other medium that can carry or store an expected program code in a form of an instruction or a data structure and can be accessed by a computer, but is not limited thereto.

The processor 1202 is configured to execute the program code stored in the memory 1203, and is specifically configured to perform the method described in the embodiment shown in FIG. 5 or FIG. 8. The method described in the embodiment shown in FIG. 5 or FIG. 8 can be referred to, and details in this application are not described herein.

A specific connection medium between the communications interface 1201, the processor 1202, and the memory 1203 is not limited in this embodiment of this application. In this embodiment of this application, in FIG. 12, the memory 1203, the processor 1202, and the communications interface 1201 are connected to each other through a bus 1204. The bus is represented by using a bold line in FIG. 12. A manner of connection between other components is only schematically described, but is not used as a limitation. The bus may be classified into an address bus, a data bus, a control bus, and the like. For ease of representation, the bus is represented by using only one bold line in FIG. 12. However, it does not mean that there is only one bus or only one type of bus.

An embodiment of this application further provides a computer-readable storage medium, configured to store a computer software instruction that requires to be executed for performing the processor. The computer software instruction that requires to be performed is executed, so that the foregoing method embodiments can be implemented.

Some wordings in this application are explained below for ease of understanding by a person skilled in the art.

(1) User equipment in the embodiments of this application may alternatively be referred to as a terminal device, and is a device in which various communications applications can be installed or that has a communications function. For example, the terminal device may be a smartphone, a tablet computer, various wearable devices, a vehicular device, a computer, or the like.

(2) In descriptions of this application, words such as “first” and “second” are merely intended for purposes of description, and should not be understood as indicating or implying relative importance or a sequence.

Persons skilled in the art should understand that the embodiments of this application may be provided as a method, a system, or a computer program product. Therefore, this application may use a form of hardware only embodiments, software only embodiments, or embodiments with a combination of software and hardware. Moreover, this application may use a form of a computer program product implemented on one or more computer-usable storage media (including but not limited to a magnetic disk storage, a CD-ROM, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may alternatively be stored in a computer-readable memory that can instruct the computer or any other programmable data processing device to work in a specific manner, so that the instructions stored in the computer-readable memory generate an artifact that includes an instruction apparatus. The instruction apparatus implements a specified function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or any other programmable device provide steps for implementing a specific function in one or more processes in the flowcharts and/or in one or more blocks in the block diagrams.

Apparently, persons skilled in the art can make various modifications and variations to this application without departing from the spirit and scope of this application. This application is intended to cover these modifications and variations of this application provided that they fall within the protection scope defined by the following claims of this application and their equivalent technologies.

What is claimed is:

1. A method for establishing a user equipment cooperation group, comprising:
receiving, by a neighboring user equipment (NUE), a first message sent by a target user equipment (TUE), wherein the first message comprises a first preamble sequence and a data part of the TUE, and the first preamble sequence is used for random access between the TUE and the NUE;
sending, by the NUE, a second message to a base station, wherein the second message comprises a second preamble sequence and a data part of the NUE, and the second preamble sequence is used for random access between the NUE and the base station; and
receiving, by the NUE, a third message sent by the base station, wherein the third message comprises a user equipment cooperation group identifier.

2. The method according to claim 1, wherein the data part of the TUE comprises at least one of identification information of the TUE or user equipment cooperation request information of the TUE.

3. The method according to claim 2, wherein the data part of the TUE further comprises type indication information, wherein the type indication information is used to indicate a type of the first message.

4. The method according to claim 1, wherein the data part of the NUE comprises at least one of identification information of the NUE, identification information of the TUE, an index of the first preamble sequence, or a channel quality indicator of the TUE.

5. The method according to claim 4, wherein the data part of the NUE further comprises type indication information, wherein the type indication information is used to indicate a type of the second message.

6. A neighboring user equipment (NUE), comprising:
a receiving unit, configured to receive a first message sent by a target user equipment (TUE), wherein the first message comprises a first preamble sequence and a data part of the TUE, and the first preamble sequence is used for random access between the TUE and the NUE; and
a sending unit, configured to send a second message to a base station, wherein the second message comprises a second preamble sequence and a data part of the NUE, and the second preamble sequence is used for random access between the NUE and the base station; wherein
the receiving unit is further configured to receive a third message sent by the base station, and the third message comprises a user equipment cooperation group identifier.

7. The NUE according to claim 6, wherein the data part of the TUE comprises at least one of identification information of the TUE /or user equipment cooperation request information of the TUE.

8. The NUE according to claim 7, wherein the data part of the TUE further comprises type indication information, wherein the type indication information is used to indicate a type of the first message.

9. The NUE according to claim 6, wherein the data part of the NUE comprises at least one of identification information of the NUE, identification information of the TUE, an index of the first preamble sequence, or a channel quality indicator of the TUE.

10. The NUE according to claim 9, wherein the data part of the NUE further comprises type indication information, wherein the type indication information is used to indicate a type of the second message.

11. A target user equipment (TUE), comprising:
a receiving unit, configured to receive radio resource control (RRC) signaling sent by a base station;
a processing unit, configured to determine, based on the RRC signaling, a device to device (D2D) physical random access channel (PRACH) resource that is configured by the base station for the TUE; and
a sending unit, configured to send a first message to a neighboring user equipment (NUE) through the D2D PRACH resource, wherein the first message comprises a first preamble sequence and a data part of the TUE, and the first preamble sequence is used for random access between the TUE and the NUE; wherein
the receiving unit is further configured to receive a fourth message sent by the base station, wherein the fourth message comprises a user equipment cooperation group identifier.

12. The TUE according to claim 11, wherein the data part of the TUE comprise s at least one of identification information of the TUE or user equipment cooperation request information of the TUE.

13. The TUE according to claim 12, wherein the data part of the TUE further comprises type indication information, wherein the type indication information is used to indicate a type of the first message.

14. The TUE according to claim 11, wherein the fourth message further comprises a random access response (RAR) and contention resolution information.

15. The TUE according to claim 11, wherein the fourth message further comprises identification information of the NUE that becomes a cooperating user equipment (CUE) of the TUE.

16. Abase station, comprising:
a sending unit, configured to send radio resource control (RRC) signaling to a target user equipment (TUE), wherein the RRC signaling is used to indicate a device to device (D2D) physical random access channel (PRACH) resource that is configured by the base station for the TUE;
a receiving unit, configured to receive a second message sent by a neighboring user equipment (NUE) of the TUE, wherein the second message comprises a second preamble sequence and a data part of the NUE, and the second preamble sequence is used for random access between the NUE and the base station; and
a processing unit, configured to determine, based on the second message, a user equipment cooperation group, and allocate a user equipment cooperation group identifier, wherein
the sending unit is further configured to send a third message to the NUE and a fourth message to the TUE, and wherein both the third message and the fourth message comprise the user equipment cooperation group identifier.

17. The base station according to claim 16, wherein the third message further comprises identification information of the TUE.

18. The base station according to claim 16, wherein the fourth message further comprises identification information of the NUE that becomes a cooperating user equipment (CUE) of the TUE.

19. The base station according to claim 16, wherein the data part of the NUE comprises at least one of identification information of the NUE, identification information of the TUE, an index of a first preamble sequence, or a channel quality indicator of the TUE.

20. The base station according to claim 19, wherein the data part of the NUE further comprises type indication information, wherein the type indication information is used to indicate a type of the second message.
